(19) United States
(12) Patent Application Publication
(10) Pub. No.: US 2024/0330721 A1
(43) Pub. Date: Oct. 3, 2024

(54) SELECTIVE DATA RETENTION IN A GROUNDING BASED APPLICATION

(71) Applicant: International Business Machines Corporation, Armonk, NY (US)

(72) Inventors: Venkatesan Thirumalai Chakaravarthy, Bangalore (IN); Anamitra Roy Choudhury, New Delhi (IN); Ananda Sankar Pal, Hooghly (IN); Yogish Sabharwal, Gurgaon (IN)

(73) Assignee: International Business Machines Corporation, Armonk, NY (US)

(21) Appl. No.: 18/127,784

(22) Filed: Mar. 29, 2023

(51) Int. Cl. G06N 5/04; G06N 3/02

(52) U.S. Cl. CPC G06N 5/04; G06N 3/02

(57) ABSTRACT

An embodiment includes configuring a grounding based application (GBA) structure comprising a plurality of layers, where the plurality of layers comprises a first layer and a second layer, the first layer having a first node that receives an input associated with a child node responsive to an input query, and the second layer having a second node that outputs a response to the input query. The embodiment also includes evaluating, using the GBA structure, a logical inference based on the input query, where the evaluating comprises generating a first truth table associated with the first node, where the generating of the first truth table comprises retaining truth values resulting from a downward inference pass on the GBA structure and discarding truth values resulting from an upward inference pass on the GBA structure. The embodiment also includes outputting, responsive to the evaluating, an output truth value representative of the logical inference.

### BACKGROUND

The present invention relates generally to memory management in processor-based devices. More particularly, the present invention relates to a method, system, and computer program for selective data retention in a grounding based application.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. A feedforward neural network is an artificial neural network where connections between the units do not form a cycle.

In machine learning, a convolutional neural network (CNN) is a type of feed-forward artificial neural network in which the connectivity pattern between the nodes (neurons) is inspired by the organization of the animal visual cortex, whose individual neurons are arranged to respond to overlapping regions tiling a visual field. Convolutional networks mimic biological processes and are configured as variations of multilayer perceptrons designed to use minimal amounts of preprocessing while processing data, such as digital images.

Convolutional neural networks (CNN) are networks with overlapping “reception fields” performing convolution tasks. A CNN is particularly efficient in recognizing image features, such as by differentiating pixels or pixel regions in a digital image from other pixels or pixel regions in the digital image. Generally, a CNN is designed to recognize images or parts of an image, such as detecting the edges of an object recognized on the image. Computer vision is a field of endeavor where CNNs are commonly used.

Recurrent neural networks (RNN) are networks with recurrent connections (going in the opposite direction that the “normal” signal flow) which form cycles in the network's topology. In RNNs, a neuron feeds back information to itself in addition to passing it to the next neuron in the RNN. Computations derived from earlier input are fed back into the network, which gives an RNN something similar to a short-term memory. Feedback networks, such as RNNs, are dynamic; their ‘state’ is changing continuously until they reach an equilibrium point. For this reason, RNNs are particularly suited for detecting relationships across time in a given set of data. Long-Short Term Memory (LSTM) and Gated Recurrent Units (GRU) are types of RNNs that include a state preserving mechanism through built-in memory cells. These types of RNNs are particular suited for multi-variate time series data analysis and forecasting, handwriting recognition, natural language processing and task synthesis.

A deep neural network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

A logical neural network (LNN) is a form of RNN with a 1-to-1 correspondence to a set of logical formulae in any of various systems of weighted, real-valued logic, in which evaluation performs logical inference. The graph structure therefore directly reflects the logical formulae it represents. One distinction of LNNs compared to other types of neural networks is that their neural activation functions are constrained to implement the truth functions of the logical operations they represent, i.e. And, Or, Not, Implies, etc. Also, in an LNN, results are expressed in terms of bounds on truth values so as to distinguish known, approximately known, unknown, and contradictory states.

### SUMMARY

The illustrative embodiments provide for selective data retention in a grounding based application. An embodiment includes configuring a grounding based application (GBA) structure comprising a plurality of layers, wherein the plurality of layers comprises a first layer and a second layer, the first layer having a first node that receives an input associated with a child node responsive to an input query, and the second layer having a second node that outputs a response to the input query. The embodiment also includes evaluating, using the GBA structure, a logical inference based on the input query, where the evaluating comprises generating a first truth table associated with the first node, where the generating of the first truth table comprises retaining truth values resulting from a downward inference pass on the GBA structure and discarding truth values resulting from an upward inference pass on the GBA structure. The embodiment also includes outputting, responsive to the evaluating, an output truth value representative of the logical inference. Other embodiments of this aspect include corresponding computer systems, apparatus, and computer programs recorded on one or more computer storage devices, each configured to perform the actions of the embodiment.

In some embodiments, the upward inference pass on the GBA structure includes evaluating an expression associated with a first operator using data from the child node, and the downward inference pass on the GBA structure includes evaluating the expression associated with a second operator using data from a parent node.

Some embodiments include grouping the plurality of layers of the GBA structure into a plurality of segments, where the plurality of segments includes a first segment, wherein the first segment includes a plurality of segment layers between a first snapshot layer and a second snapshot layer. In some such embodiments, the evaluating comprises a plurality of iterations each having respective pairs of upward and downward inference passes. In some such embodiments, the evaluating comprises generating a second truth table associated with the second node, where the performing of the upward inference pass comprises determining that the first node is on one of the segment layers and the node is on one of the snapshot layers.

In some such embodiments, the generating of the first truth table comprises discarding the truth values resulting from the upward inference pass based at least in part on the determining that the first node is on one of the segment layers. In some such embodiments, the generating of the second truth table comprises retaining truth values resulting from the upward inference pass based at least in part on the determining that the second node is on the first snapshot layer.

In some embodiments, the performing the downward inference pass on the GBA structure comprises reconstructing data associated with the first node using data associated with the second node. In some such embodiments, the reconstructing of the data associated with the first node comprises performing a mini upward inference pass on only the segment layers of the first segment. In some such embodiments, the performing the downward inference pass on the GBA structure comprises discarding data associated with node on the segment layers of the first segment before performing the downward inference pass on segment layers of a second segment of the plurality of segments.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example service infrastructure in accordance with an illustrative embodiment;

FIG. 3 depicts a functional block diagram of an exemplary processing environment in accordance with an illustrative embodiment;

FIG. 4 depicts a functional block diagram of an exemplary GBA data management module in accordance with an illustrative embodiment;

FIG. 5 depicts a functional block diagram of an exemplary GBA data management module in accordance with an illustrative embodiment;

FIG. 6 depicts a functional block diagram of an exemplary GBA data management module in accordance with an illustrative embodiment;

FIG. 7 depicts a generalized block diagram of an exemplary LNN in accordance with an illustrative embodiment;

FIG. 8 depicts a block diagram of an exemplary data management process for an LNN in accordance with an illustrative embodiment;

FIG. 9 depicts a block diagram of an exemplary data management process for a segmented LNN in accordance with an illustrative embodiment;

FIG. 10 depicts a block diagram of an exemplary data management process for a segmented LNN in accordance with an illustrative embodiment;

FIG. 11 depicts a block diagram of an exemplary downward pass for a segmented LNN in accordance with an illustrative embodiment;

FIG. 12 depicts a flowchart of an example process for selective data retention in a logical neural network in accordance with an illustrative embodiment; and

FIG. 13 depicts a simplified block diagram of an example LNN in accordance with an illustrative embodiment.

### DETAILED DESCRIPTION

Once knowledge has been ingested into a knowledge base, it can be used to answer questions/queries through logical inference, deriving new expressions from those contained in the knowledge base. This may be accomplished using a (GBA). An example of an GBA is a logical neural network (LNN). While embodiments are described herein with reference to an LNN, such references are not intended to be limiting, but are instead provided for explanatory purposes.

An LNN is a neural network that has a 1-to-1 correspondence with a system of logical formulae. The LNN represents an advancement in neural network architectures in that it introduces an architecture that is the first to simultaneously consolidate numerous key properties from both neural networks (learning) and symbolic logic (reasoning). For example, the LNN provides a system that is fully differentiable, symbolically interpretable, incorporates domain knowledge, supports compound first-order-logic (FOL) formulae and adheres to the open-world assumption. The LNN also expands on traditional neural net inputs by incorporating both rules and facts into its graph structure.

Exemplary embodiments of an LNN include a feed-forward recurrent neural network with: a) Neurons arranged to match a system of formulae; b) Constrained neural weights to ensure classical logic behavior; and c) Families of neurons sharing related weights to perform inference. Unlike other neural networks, LNNs are different because: Neurons yield (tensors of) bounds pairs; and alternately, pairs of neurons with matching weights that exist for either bound.

The LNN is represented as a structured graph, having neurons and interconnecting edges between neurons that establish positive and negative correlations between truth values. Any node can be an input or output. The LNN truth values are not required to have a probability interpretation and do not require a costly normalization. Special cases of LNNs can be developed that present results that do have probability interpretations. The inference in an LNN involves multiple upward and downward iterations, and in an iteration, the tuples of a neuron are updated by doing some operation (e.g., joins) on the tuples of its child nodes (in upward) or parent nodes (in downward). Thus, the number of tuples (groundings) can grow enormously, depending on the operations involved, and in general for a deep network involving a large number of neurons.

Inputs are initial truth value bounds for each of the neurons in the network; in particular, neurons pertaining to predicate atoms may be populated with truth values taken from knowledge base data. Additional inputs may take the form of injected formulae representing a query or specific inference problem. Outputs are typically the final computed truth value bounds at one or more neurons pertaining to specific atoms or formulae of interest. In other problem contexts, the outputs of interest may instead be the neural parameters themselves—serving as a form of inductive logic programming (ILP)—after learning with a given loss function and input training data set.

LNNs are typically executed using graphics processing units (GPUs) or accelerators because such devices offer superior support for parallel processing compared to central processing units (CPUs). On the other hand, GPUs/Accelerators have limited memory that may be insufficient for some LNN applications. Thus, it is significant to design a memory efficient inference/training mechanism for LNNs that reduce the working memory requirements, allowing an LNN to run more efficiently.

Exemplary embodiments address the above and other challenges associated with LNNs by provided memory optimization techniques for data associated with and/or generated by an LNN. The disclosed memory optimization techniques allow for significant reductions in the amount of data being retained at numerous processing stages of an LNN. The result is a significant reduction in memory requirements for traditionally memory-intensive operations.

In an exemplary embodiment, an LNN has a graph structure of neurons that include neurons arranged in layers and connected by operators. LNN processing involves iterating through several iterations, where each iteration includes an upward (or forward) inferential pass and then a downward (or backwards) inferential pass through the graph structure, following paths representative of subformulae. In some embodiments, each neuron is associated with a respective truth table that stores truth value data about the associated neuron. As the iterations progress, the truth value data in the truth tables typically continues to grow and is retained for what the truth value data informs about the associated neuron and for what the truth value data infers about parent or child nodes.

Exemplary embodiments reduce the amount of data that is stored in the data tables without negatively affecting the LNN's ability to infer information about the nodes. In some embodiments, a memory management technique is based on observations about the behavior of the processing performed by an LNN, particularly with respect to the iterations of upward and downward inferential passes through the graph structure. Data that is stored in data tables during a forward pass may often be needed by the downward pass that follows. However, it has been observed that the data generated by an upward pass is usually significantly larger than the data generated by the subsequent downward pass in an LNN. Often the data generated by the upward pass is a subset of the data generated by an upward pass in the next iteration. Thus, the upward inferential pass will generate a superset of the data generated by the previous upward inferential pass. Therefore, disclosed embodiments employ memory management techniques that discard portions of the data that is generated by the LNN when the data meets conditions indicative of the data reconstructable by the LNN.

In an exemplary embodiment, a memory management process for an LNN stores data used for intermediate operations of the LNN in their entirety only at nodes belonging to segment boundary layers, also referred to as snapshot layers. For other segment layers, the process stores only a portion of the data (referred to as the delta or the delta data) and discards data that can later be reconstructed. The delta data for a node of the LNN corresponds to data that cannot easily be regenerated. Other discarded data for a node may be regenerated by joins of the node's immediate child nodes.

In an exemplary embodiment, the memory management process configures a logical neural network (LNN) structure comprising a plurality of layers, where the plurality of layers comprises an input layer and an output layer connected by a plurality of intermediate layers. The process evaluates, using the LNN structure, a logical inference based on the input query. The evaluation includes generating a truth table associated with a neuron, where the generating of the truth table comprises retaining truth values resulting from a downward inference pass on the LNN structure and discarding truth values resulting from an upward inference pass on the LNN structure. The process also outputs an output truth value representative of the logical inference.

In an exemplary embodiment, the memory management process includes an upward inference pass on the LNN structure that evaluates an expression associated with an operator using data from a child neuron. The process also includes a downward inference pass on the LNN structure that evaluates an expression associated with another operator using data from a parent neuron.

In an exemplary embodiment, the memory management process groups the plurality of layers of the LNN structure into a plurality of segments. Each segment includes a plurality of segment layers between a first snapshot layer and a second snapshot layer. In some such embodiments, the process performs a plurality of iterations, with each iteration involving respective pairs of upward and downward inference passes. During the iterations, the process generates sets of truth values for each neuron. In some embodiments, the process determines whether a neuron is on a segment layer or a snapshot layer. For neurons on segment layers, the process discards truth values resulting from the upward inference pass. For neurons on snapshot layers, the process retains truth values resulting from the upward inference pass.

In some embodiments, during the downward pass, the process reconstructs the data discarded from the segment-layer neurons using data from snapshot-layer neurons. In some such embodiments, the process reconstructs the data by performing a mini upward inference pass on only the segment layers of a segment being processed. In some such embodiments, the process then performs the downward inference pass and discarding temporary data associated with the segment-layer neurons before performing the downward inference pass on segment layers of another segment.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

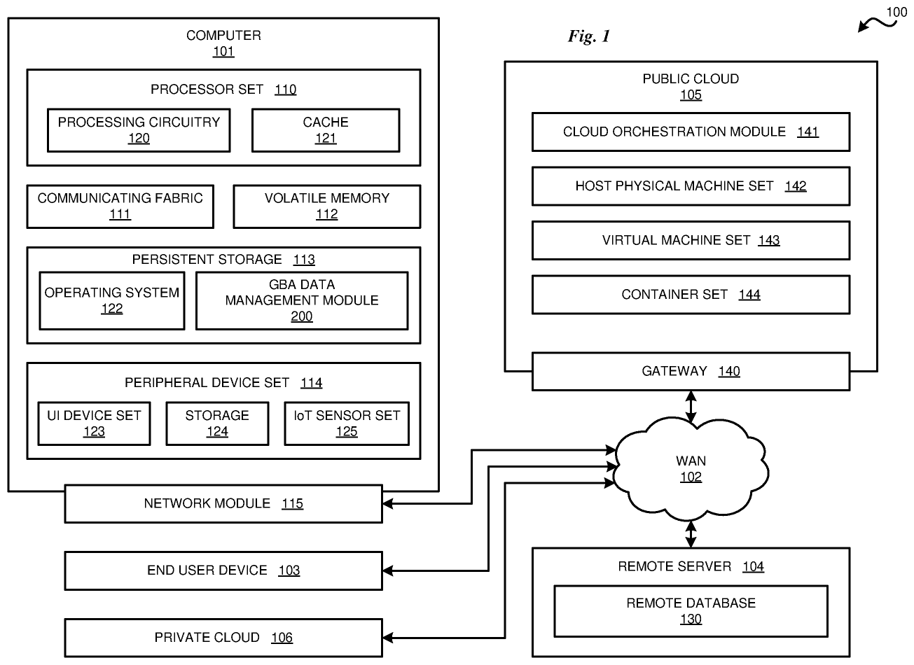

With reference to FIG. 1, this figure depicts a block diagram of a computing environment 100. Computing environment 100 contains an example of an environment for the execution of at least some of the computer code involved in performing the inventive methods, such as an improved grounding based application (GBA) module 200 that performs selective data retention in a logical neural network. In addition to GBA data management module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and GBA data management module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in GBA data management module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in GBA data management module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

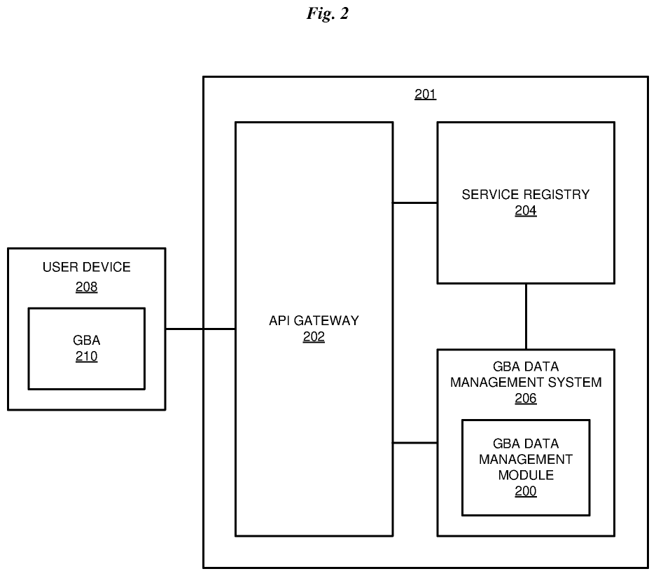

With reference to FIG. 2, this figure depicts a block diagram of an example service infrastructure 201 in accordance with an illustrative embodiment. In the illustrated embodiment, the service infrastructure 201 includes a GBA data management system 206. In an embodiment, the GBA data management system 206 is an example of the computer 101 of FIG. 1 and includes the GBA data management module 200 of FIG. 1.

In the illustrated embodiment, the service infrastructure 201 provides services and service instances to a user device 208 running a GBA 210. User device 208 communicates with service infrastructure 201 via an API gateway 202. API gateway 202 provides access to client applications like the GBA data management module 200. API gateway 202 receives service requests issued by client applications and creates service lookup requests based on service requests. As a non-limiting example, in an embodiment, the GBA 210 running on user device 208 executes a routine to initiate interaction with the GBA data management module 200. For instance, in some embodiments, the GBA 210 executes a routine to initiate data management processes of the GBA data management module 200.

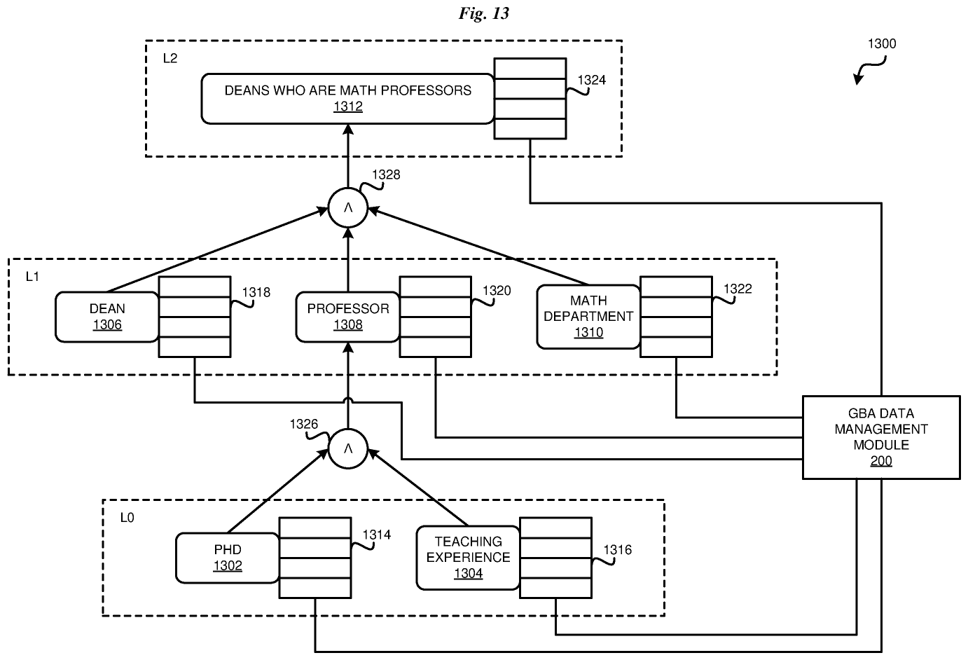

Referring now also to FIG. 13, this figure depicts a simplified block diagram of an example LNN 1300 in accordance with an illustrative embodiment. The LNN 1300 is a graph made up of syntax trees corresponding to represented formulae. The graph includes neurons 1302-1312 and operators 1326 and 1328. Each of the neurons 1302-1312 is associated with a respective one of the truth tables 1314-1324 that stores associated truth value data. The GBA data management module 200 manages storage of the data of the truth tables 1314-1324 according to embodiments disclosed herein.

Neurons 1302-1312 each correspond to a unique proposition in a represented formula, and operators 1326 and 1328 each correspond to logical operations in a represented formula. As mentioned above, each of the neurons 1302-1312 is associated with a respective one of the truth tables 1314-1324. Each of the truth tables 1314-1324 stores truth value data that maps a set of n-dimensional grounding tuples to truth value bounds, where n is the number of unique variables in the underlying subformula. The truth value bounds are pairs of values in the range [0, 1] representing lower and upper bounds on the truth values of their corresponding subformulae and propositions. A truth threshold 1/2<α≤1 is defined such that a continuous truth value is considered True if it is greater than a and False if it is less than 1−α.

In an LNN as referred to herein, a “layer” of an LNN refers to layers of neurons and their respective truth tables. For example, in FIG. 13, the LNN 1300 has three layers: L0, L1, and L2. A “node” as referred to herein refers to a neuron. Thus, the LNN relationship model 1300 has six nodes: neuron 1302, neuron 1304, neuron 1306, neuron 1308, neuron 1310, and neuron 1312. A “parent node” as referred to herein thus refers to a connected neuron on a next-higher layer of the LNN, whereas a “child node” as referred to herein refers to a connected neuron on a next-lower layer of the LNN. For example, neuron 1308 is a parent node of neuron 1302 and is a child node of neuron 1312.

An LNN, such as LNN 1300, makes predictions at neurons pertaining to queried formulae using inference to compute truth value bounds for (sub)formulae and atoms based on initial knowledge. The LNN achieves this with multiple passes over the represented formulae, propagating tightened truth value bounds from neuron to neuron until computation necessarily converges. The multiple passes are a series of pairs of upward and downward passes of inference. For an upward pass, truth value bounds are computed for represented formulae at operators 1326 and 1328, which output the truth value bounds to the truth table of the output-connected neuron. For example, the operator 1326 will output truth value bounds to the truth table 1320 for the neurons 1302 and 1304 that, together with the operator 1326, represent a rule that “to be a Professor you must have a Ph.D and Teaching Experience.” The upward pass is followed by a downward pass, which permits prior belief in the truth or falsity of formulae to inform truth value bound for propositions or predicates used in said formulae. For example, if data stored in truth table 1320 for a given subject indicates that the given subject is known to be a professor, then the downward pass generates truth values for the neurons 1302 and 1304 because the given subject must also have a PhD and Teaching Experience.

Referring again to FIG. 2, in some embodiments, user device 208 connects with API gateway 202 via any suitable network or combination of networks such as the Internet, etc. and uses any suitable communication protocols such as Wi-Fi, Bluetooth, etc. Service infrastructure 201 may be built on the basis of cloud computing. In various embodiments, service infrastructure 201 and its associated GBA data management system 206 serve multiple users and multiple tenants. A tenant is a group of users (e.g., a company) who share a common access with specific privileges to the software instance. Service infrastructure 201 ensures that tenant specific data is isolated from other tenants.

In the illustrated embodiment, service infrastructure 201 includes a service registry 204. In some embodiments, the GBA data management system 206 is a virtual machine and the service registry 204 looks up service instances of GBA data management system 206 in response to a service lookup request such as one from API gateway 202 in response to a service request from user device 208. For example, in some embodiments, the service registry 204 looks up service instances of GBA data management system 206 in response to requests related to GBA queries from the user device 208.

In some embodiments, service registry 204 maintains information about the status or health of each service instance including performance information associated each of the service instances. In some such embodiments, such information may include various types of performance characteristics of a given service instance (e.g., cache metrics, etc.) and records of updates.

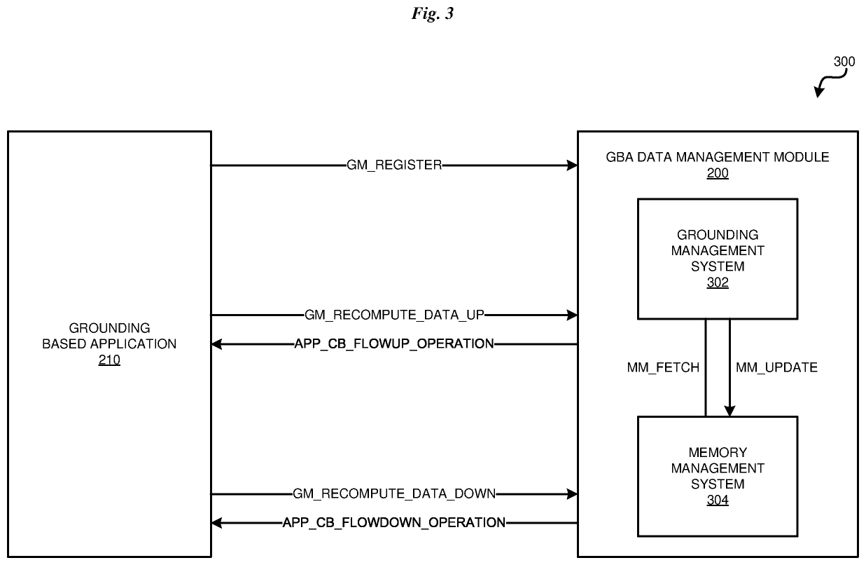

With reference to FIG. 3, this figure depicts a functional block diagram of an exemplary processing environment 300 in accordance with an illustrative embodiment. In the illustrated embodiment, the processing environment 300 includes the GBA data management module 200 of FIG. 1.

In the illustrated embodiment, the processing environment 300 includes a GBA 210 in communication with a GBA data management module 200. The GBA data management module 200 comprises a grounding management system 302 and a memory management system 304. In alternative embodiments, the application 302 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the GBA 210 is any type of program or application that receives one or more prediction inputs in the form of input prediction queries and input facts and uses an LNN to generate a response to the input query. As a non-limiting example, the GBA 210 can use an LNN to generate query results, i.e., answers to a posed query, such as “Does this picture include a cat?” The GBA 210 will output the answer for receipt by and/or for presentation to a user via a computer or mobile device display.

In the illustrated embodiment, the GBA data management module 200 provides memory management for the GBA 210 by performing processes that improve the efficiency of the usage of working memory by the GBA 210 according to embodiments disclosed herein. The grounding management system 302 performs forward (upward) and backwards (downward) flows on a knowledge graph or the like at the GBA 210. During these flows, the grounding management system 302 selectively retains and discards data of individual neurons. This avoids the enormous growth of data tables associated with the neurons that might otherwise occur.

During the upward and backward flows, there is various temporary data that needs to be stored temporarily during the pass. This leads to high levels of intra-iteration memory usage. To avoid this problem, the memory management system 304 segments the LNN into groups of layers. The memory is then used to process one segment at a time. The memory management system 304 can avoid the need for memory for the data of the other segments by creating snapshot layers that store data that can be used to reconstruct other layers of the same segment.

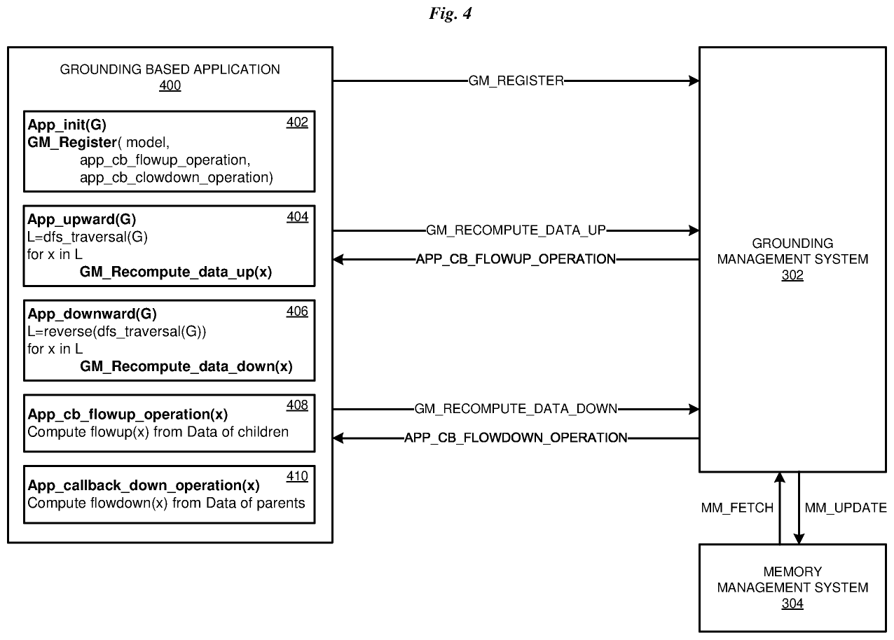

With reference to FIG. 4, this figure depicts a functional block diagram of an exemplary GBA data management module in accordance with an illustrative embodiment. In an exemplary embodiment, the groundings base application 400 is an example of the groundings base application 210 of FIGS. 2 and 3.

In the illustrated embodiment, the application development environment 400 includes machine readable code stored on a computer readable storage medium. The machine readable code corresponds to the pseudocode 402-410 shown in FIG. 4 for initiates app and callback upflow and downflow operations on an LNN.

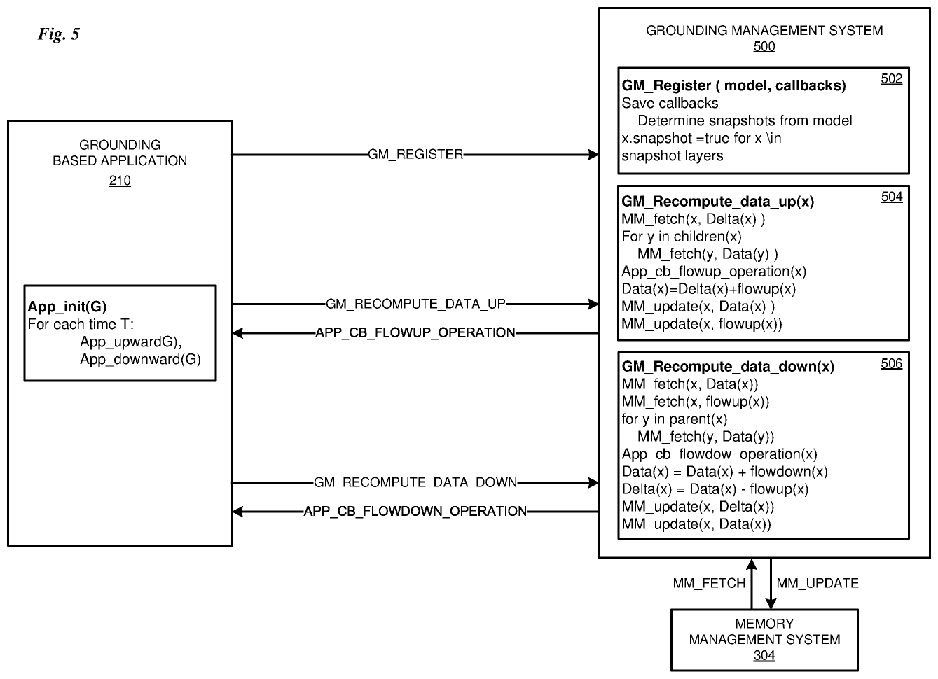

With reference to FIG. 5, this figure depicts a functional block diagram of an exemplary GBA data management module in accordance with an illustrative embodiment. In an exemplary embodiment, the grounding management system 500 is an example of the grounding management system 302 of FIGS. 3 and 4.

In the illustrated embodiment, the grounding management system 500 includes machine readable code stored on a computer readable storage medium. The machine readable code corresponds to the pseudocode 502-506 shown in FIG. 5 for determining snapshot layers of a segmented LNN and reconstructing or recomputing data of a segment of layers of the LNN.

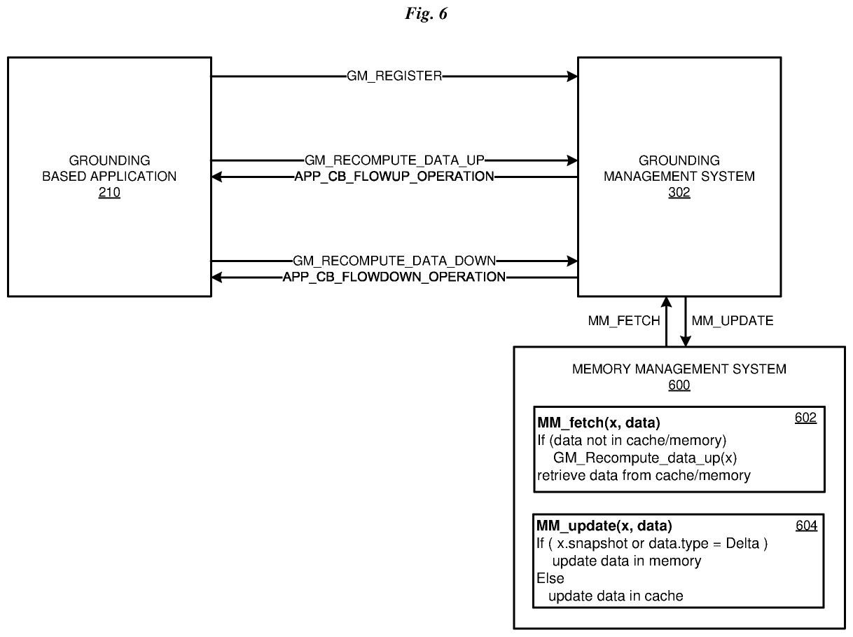

With reference to FIG. 6, this figure depicts a functional block diagram of an exemplary GBA data management module in accordance with an illustrative embodiment. In an exemplary embodiment, the memory management system 600 is an example of the memory management system 304 of FIGS. 3 through 5.

In the illustrated embodiment, the memory management system 600 includes machine readable code stored on a computer readable storage medium. The machine readable code corresponds to the pseudocode 602 and 604 shown in FIG. 6 for fetching and updating neuron data.

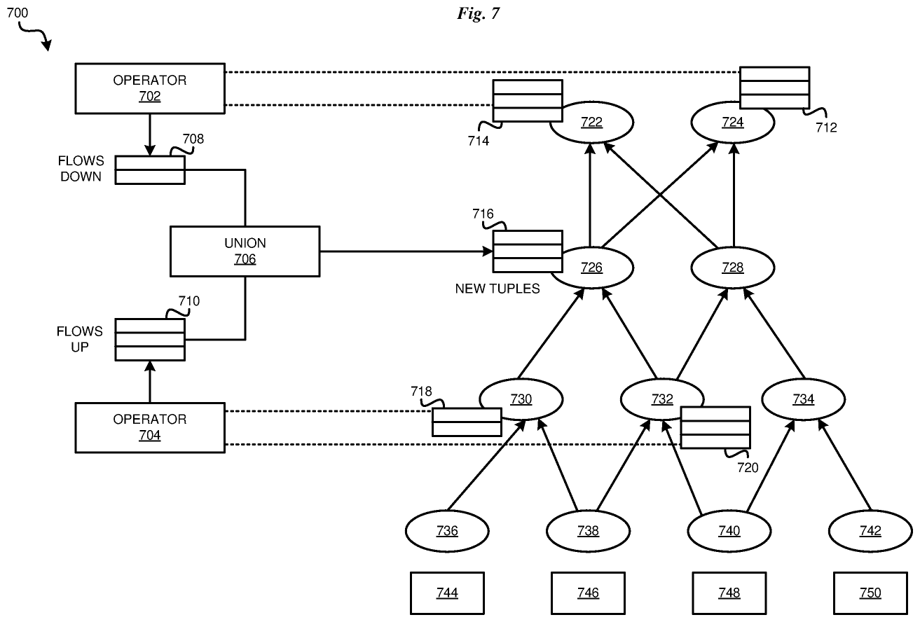

With reference to FIG. 7, this figure depicts a generalized block diagram of an exemplary LNN 700 in accordance with an illustrative embodiment. For the sake of simplicity, operators are not shown in FIG. 7, except for noted exceptions described below. In an exemplary embodiment, the LNN 700 computes two types of inferences-forward inferences and backward inferences-during each iteration of operation. The block diagram in FIG. 7 shows the functional equivalence of a forward inference pass and a subsequent backward inference pass on a node 726 during an iteration of operation.

In the illustrated embodiment, the example LNN 700 includes a graph structure that includes a neural net having a 1-to-1 correspondence with a system of logical formulae, in which evaluation is equivalent to a logical inference. The LNN 700 structure is a neural network structure of nodes (i.e., neurons) 722-742 configured for receiving inputs according to the type of inference problem being solved. In some embodiments, the LNN 700 is a graph comprising the syntax trees of formulae in a represented knowledgebase (KB).

In some embodiments, the nodes return pairs of values that are stored in associated truth tables 712-720 in the range [0,1] representing upper and lower bounds on the truth values of their corresponding subformulae and input values 744-750. In some embodiments, fuzzy logic is employed that provides degrees of truth values that range between zero and one, i.e., values in between 0 and 1 representative probabilities of truth rather than discrete indications of true or false. In an embodiment, alpha a is defined as a threshold of truth ranging between, e.g., 0.5<α≤1. Thus, any evaluated truth value is constrained such that values above a are considered “True” and any truth value less than a quantity 1−α is considered “false.”

When a forward inference pass is performed, expressions are evaluated first to come up with truth values at each node. FIG. 7 shows an example of a forward and backwards pass for node 726. In the illustrated example, an operator 704 evaluates the truth value data from truth table 718 (associated with node 730) and from truth table 720 (associated with node 732) resulting in upflow data table 710. During a backwards (downward) inference pass, a recursive depth-first traversal is performed from each root to each of its leaves, performing inverse inference rules along the way, generally resulting in the tightening of upper and lower bounds. In the illustrated example, an operator 702 evaluates the truth value data from truth table 714 (associated with node 722) and from data table 712 (associated with node 724) resulting in downflow data table 708. The cumulative effect of the upflow and downflow passes is functionally equivalent to the union 706 that results in updated truth value data for truth table 716.

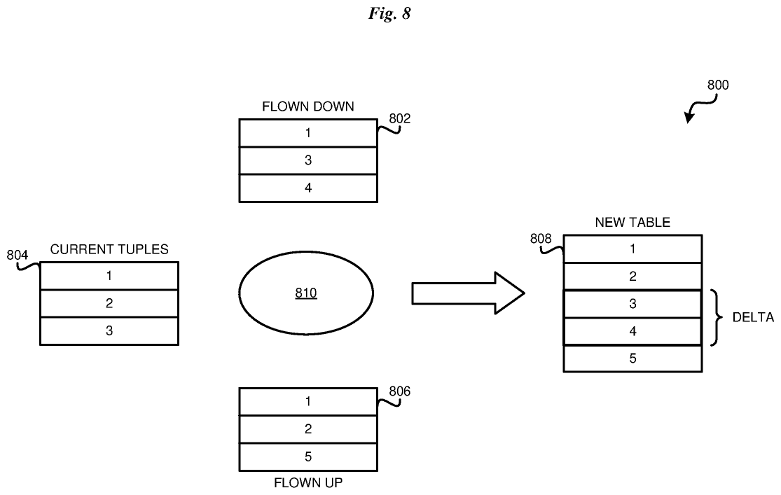

With reference to FIG. 8, this figure depicts a block diagram of an exemplary data management process for an LNN in accordance with an illustrative embodiment. This figure shows a specific example 800 of the updating of the data table 716 in FIG. 7, where neuron 810 is an example of neuron 726, downflow data table 802 is an example of downflow data table 708, upflow data table 806 is an example of upflow data table 710, current data table 804 is an example of data table 716 before being updated, and new data table 808 is an example of data table 716 after being updated.

In the illustrated embodiment, when a forward inference pass is performed, the is the data in upflow data table 806. During a backwards (downward) inference pass, a recursive depth-first traversal of the tree is performed, resulting in downflow data table 802. The (union 706 of FIG. 7) of downflow data table 802 and upflow data table 806 on original data table 804 results in new data table 808.

In some embodiments, some of the data in the new data table 808 is discarded to allow for more efficient memory usage. As shown in FIG. 8, some data elements of the new data table 808 are designated as DELTA data. The DELTA data is the data of the downflow data table 802 that is not included in the upflow data table 806. The DELTA data (3, 4) is then retained in the new data table 808 and the remaining data (1, 2, 5) is discarded.

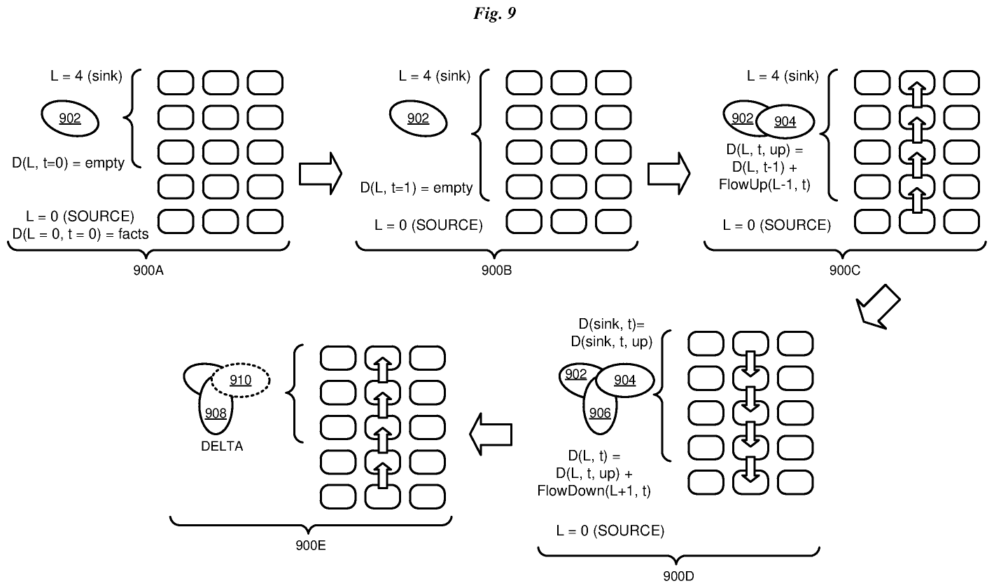

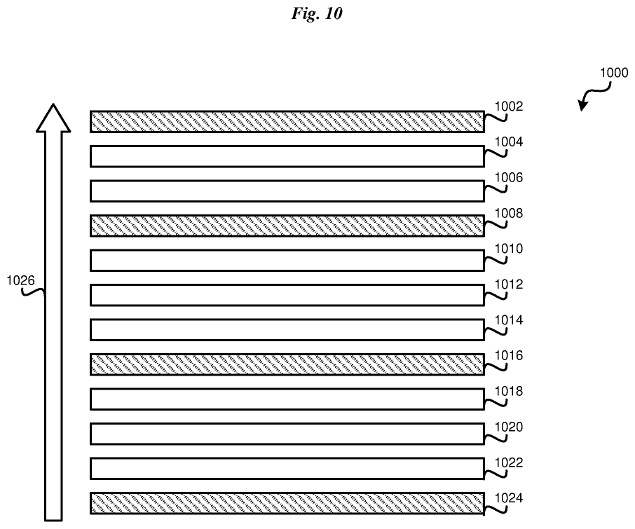

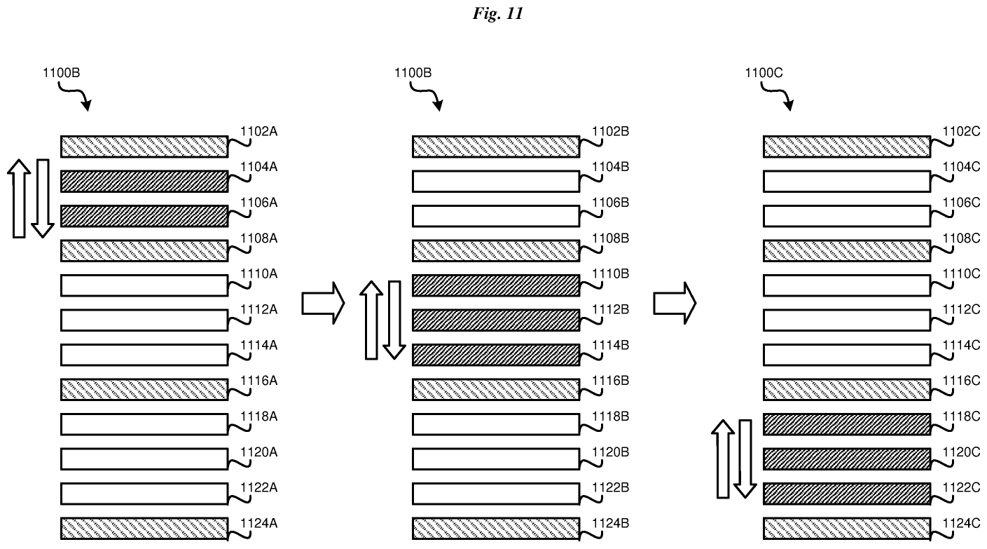

With reference to FIG. 9, this figure depicts a block diagram of an exemplary data management process for a segmented LNN in accordance with an illustrative embodiment. As also shown in FIGS. 10 and 11, in some embodiments, the layers of an LNN structure are grouped into a plurality of segments. For the sake of simplicity, operators are not shown in FIGS. 9 through 11. Each segment includes one or more layers of the LNN (referred to as segment layers) between a pair of snapshot layers. In some embodiments, the upward inference pass and downward inference pass process the LNN segment by segment as described in connection with FIGS. 9 through 11. In FIG. 9, a series of processing stages 900A-900E for a segment of an LNN are shown. The segment is shown with five lines and three columns as a non-limiting example. The description applies equally to other embodiments having other numbers of lines and columns.

In the illustrated embodiment, the processing begins at stage 900A at time t=0 in which, initially, source level (L=0) tables hold facts, and current data 902, which represents data in a data table of any node of any of layers 1-4 is empty. Next, at stage 900B, some number of t−1 iterations have taken place, each having an upward and a downward inference pass. The current data 902 now has data D (L, t−1).

Next, at stage 900C, an upward inference pass occurs that generates flowup data for layers 1-4 as FlowUp(L−1, t). The flowup data represents data propagated by layer L−1 to layer L via upward operators at time t. Thus, the data table now includes current data 902 and upflow data 904 such that D(L, t, up)=D(L, t−1)+FlowUp(L−1,t).

Next, at stage 900D, a downward inference pass occurs that generates flowdown data 906 for layers 0 to 3 as FlowDown(L+1, t). The flowdown data represents data propagated by layer L+1 to layer L via downward operators at time t. Thus, the data table now includes current data current data 902, upflow data 90, and downflow data downflow data 906.

Next, at stage 900E, this stage represents a stage subsequent to the stage LNN segment 900D or an alternative to the stage 900C. For stage 900E, some data elements of the data table are designated as DELTA data 908. The DELTA data 908 is the data of the downflow data table 802 that is not included in the upflow data table 806. Thus, the DELTA data can be represented as Delta (L, t)=D(L, t)-FlowUp(L−1, t). Intuitively, the data solely contributed by the downward pass.he DELTA data 908 is then retained in the data table and the remaining data 910 is discarded.

With reference to FIG. 10, this figure depicts a block diagram of an exemplary process for segmenting an LNN 1000 in accordance with an illustrative embodiment. In FIG. 10, the nodes of each layer are represented by a single block such that each of layers 1002-1024 includes one or more nodes.

During an upward inference pass from source to sink in the direction indicated by arrow 1026, temporary data is stored (including the data tables and other data) temporarily for use by the subsequent downward inference pass. In actual implementations, the amount of data being stored temporarily can grow to enormous sizes, often pushing the limits of the hardware executing the LNN or GBA. For example, graphics processing units (GPUs) and Accelerators have limited memory. Thus, it is significant to design a memory efficient inference/training mechanism for LNNs.

The embodiments shown in FIGS. 10 and 11 resolve this problem by segmenting the LNN and using the working memory for only one segment of the LNN at a time. In the illustrated embodiment, the LNN 1000 has twelve layers 1002-1024 as a non-limiting example. The segmenting process includes making a forward pass that designates certain layers as snapshot layers, and other layers as segment layers. In FIGS. 10 and 11, the broad cross-hatching indicates snapshot layers.

In the illustrated embodiment, the segmented LNN 1000 includes three segments, where each segment is bound by a respective pair of snapshot layers. Thus, segment layers 1018-1022 are bound by snapshot layers 1016 and 1024 to form a first segment, segment layers 1010-1014 are bound by snapshot layers 1016 and 1008 to form a second segment, and segment layers 1004-1006 are bound by snapshot layers 1002 and 1008 to form a third segment.

In some embodiments, the data for data tables and other temporary data is stored in its entirety only at nodes belonging to the snapshot layers (segment boundaries), while only a portion of such data is stored for the rest of the nodes on the segment layers. For the layers where only a portion of the data is retained, only the DELTA data (e.g., as described in connection with FIGS. 7-9) is retained. The DELTA data for a node corresponds to the groundings that cannot be regenerated by joins of its immediate children (had the children stored all their respective groundings). However, the remaining discarded data can be regenerated using the complete sets of data stored at the segment boundary layers (snapshot layers.

With reference to FIG. 11, this figure depicts a block diagram of an exemplary downward pass for a segmented LNN 1100 in accordance with an illustrative embodiment. The segmented LNN 1100 is shown at three different times as indicated by LNN 1100A for a first time during the downward inference pass, LNN 1100B for a second time during the downward inference pass, and by LNN 1100C for a third time during the downward inference pass.

In the illustrated embodiment, a downward inference pass begins at time 1100A. As indicated by the two vertical arrows, an upward mini pass that only covers one segment is performed on the segment layers resulting in reconstructed segment layers 1104A and reconstructed segment layer 1106A. The purpose of this first upward mini pass during a downward pass is to reconstitute all of the data for the segment layers of the segment being processed using the snapshot layers at the upper and lower boundaries. Then the downward process is performed on the first segment layers 1102A-1108A.

Next, the downward inference pass continues to the second segment at time 1100B. Now, the temporary data structures required for downward inference pass for first segment layers 1102A-1108A are discarded. As indicated by the two vertical arrows, an upward mini pass that only covers the second segment is performed on the segment layers resulting in reconstructed segment layers 1110B-1114B. The upward mini pass reconstitutes all of the data for the segment layers of the segment being processed using the snapshot layers at the upper and lower segment boundaries. Then the downward process is performed on the second segment layers 1110B-1114B.

Finally, a downward inference pass begins at time 1100C. Now, the temporary data structures required for downward inference pass for second segment layers 1110B-1114B are discarded. As indicated by the two vertical arrows, an upward mini pass that only covers one segment is performed on the segment layers resulting in reconstructed segment layers 1118C-reconstructed segment layer 1122C. The upward mini pass during reconstitutes all of the data for the segment layers of the segment being processed using the snapshot layers at the upper and lower boundaries. Then the downward process is performed on the third segment layers 1118C-1122C.

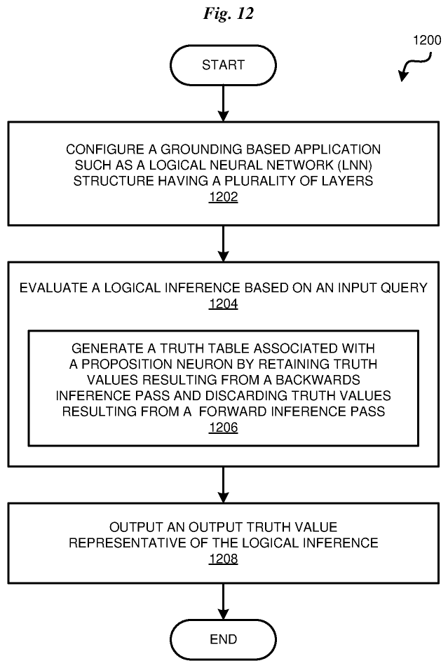

With reference to FIG. 12, this figure depicts a flowchart of an example process 1200 for selective data retention in a logical neural network in accordance with an illustrative embodiment. In a particular embodiment, the GBA data management module 200 carries out the process 1200.

In an embodiment, at block 1202, the process configures a logical neural network (LNN) structure comprising a plurality of layers, where the plurality of layers comprises a first layer and a second layer, the first layer having a first node that receives an input associated with a child node responsive to an input query, and the second layer having a second node that outputs a response to the input query. Next, at block 1204, the process evaluates, using the LNN structure, a logical inference based on the input query. As indicated at block 1206, the evaluation includes generating a first truth table associated with the first node, where the generating of the first truth table comprises retaining truth values resulting from a downward inference pass on the LNN structure and discarding truth values resulting from an upward inference pass on the LNN structure. Next, at block 1208, the process outputs, responsive to the evaluating, an output truth value representative of the logical inference.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
configuring a grounding based application (GBA) structure comprising a plurality of layers, wherein the plurality of layers comprises a first layer and a second layer, the first layer having a first node that receives an input associated with a child node responsive to an input query, and the second layer having a second node that outputs a response to the input query;
evaluating, using the GBA structure, a logical inference based on the input query, wherein the evaluating comprises generating a first truth table associated with the first node, wherein the generating of the first truth table comprises retaining truth values resulting from a downward inference pass on the GBA structure and discarding truth values resulting from an upward inference pass on the GBA structure; and
outputting, responsive to the evaluating, an output truth value representative of the logical inference.

2. The method of claim 1, further comprising:
performing the upward inference pass on the GBA structure, wherein the upward inference pass includes evaluating an expression associated with a first operator using data from the child node of the first node.

3. The method of claim 2, further comprising:
performing the downward inference pass on the GBA structure, wherein the downward pass includes evaluating an expression associated with a second operator using data from a parent node of the first node.

4. The method of claim 3, further comprising:
grouping the plurality of layers of the GBA structure into a plurality of segments, wherein the plurality of segments comprises a first segment, wherein the first segment comprises a plurality of segment layers between a first snapshot layer and a second snapshot layer.

5. The method of claim 4, wherein the evaluating comprises a plurality of iterations each having respective pairs of upward and downward inference passes.

6. The method of claim 5, wherein the evaluating comprises generating a second truth table associated with the second node, wherein the performing of the upward inference pass comprises determining that the first node is on one of the segment layers and the second node is on one of the snapshot layers.

7. The method of claim 6, wherein the generating of the first truth table comprises discarding the truth values resulting from the upward inference pass based at least in part on the determining that the first node is on one of the segment layers.

8. The method of claim 6, wherein the generating of the second truth table comprises retaining truth values resulting from the upward inference pass based at least in part on the determining that the second node is on the first snapshot layer.

9. The method of claim 8, wherein the performing of the downward inference pass on the GBA structure comprises reconstructing data associated with the first node using data associated with the second node.

10. The method of claim 8, wherein the reconstructing of the data associated with the first node comprises performing a mini upward inference pass on only the segment layers of the first segment.

11. The method of claim 8, wherein the performing the downward inference pass on the GBA structure comprises discarding data associated with nodes on the segment layers of the first segment before performing the downward inference pass on segment layers of a second segment of the plurality of segments.

12. A computer program product comprising one or more computer readable storage media, and program instructions collectively stored on the one or more computer readable storage media, the program instructions executable by a processor to cause the processor to perform operations comprising:
configuring a grounding based application (GBA) structure comprising a plurality of layers, wherein the plurality of layers comprises a first layer and a second layer, the first layer having a first node that receives an input associated with a child node responsive to an input query, and the second layer having a second node that outputs a response to the input query;
evaluating, using the GBA structure, a logical inference based on the input query, wherein the evaluating comprises generating a first truth table associated with the first node, wherein the generating of the first truth table comprises retaining truth values resulting from a downward inference pass on the GBA structure and discarding truth values resulting from an upward inference pass on the GBA structure; and
outputting, responsive to the evaluating, an output truth value representative of the logical inference.

13. The computer program product of claim 12, wherein the stored program instructions are stored in a computer readable storage device in a data processing system, and wherein the stored program instructions are transferred over a network from a remote data processing system.

14. The computer program product of claim 12, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

15. The computer program product of claim 12, further comprising:
performing the upward inference pass on the GBA structure, wherein the upward inference pass includes evaluating an expression associated with a first operator using data from the child node of the first node.

16. The computer program product of claim 15, further comprising:
performing the downward inference pass on the GBA structure, wherein the downward pass includes evaluating an expression associated with a second operator using data from a parent node of the first node.

17. The computer program product of claim 16, further comprising:
grouping the plurality of layers of the GBA structure into a plurality of segments, wherein the plurality of segments comprises a first segment, wherein the first segment comprises a plurality of segment layers between a first snapshot layer and a second snapshot layer.

18. A computer system comprising a processor and one or more computer readable storage media, and program instructions collectively stored on the one or more computer readable storage media, the program instructions executable by the processor to cause the processor to perform operations comprising:
configuring a grounding based application (GBA) structure comprising a plurality of layers, wherein the plurality of layers comprises a first layer and a second layer, the first layer having a first node that receives an input associated with a child node responsive to an input query, and the second layer having a second node that outputs a response to the input query;
evaluating, using the GBA structure, a logical inference based on the input query, wherein the evaluating comprises generating a first truth table associated with the first node, wherein the generating of the first truth table comprises retaining truth values resulting from a downward inference pass on the GBA structure and discarding truth values resulting from an upward inference pass on the GBA structure; and
outputting, responsive to the evaluating, an output truth value representative of the logical inference.

19. The computer system of claim 18, further comprising:
performing the upward inference pass on the GBA structure, wherein the upward inference pass includes evaluating an expression associated with a first operator using data from the child node of the first node.

20. The computer system of claim 19 further comprising:
performing the downward inference pass on the GBA structure, wherein the downward pass includes evaluating an expression associated with a second operator using data from a parent node of the first node.
